(19) United States
(12) Patent Application Publication
(10) Pub. No.: US 2005/0155441 A1
(43) Pub. Date: Jul. 21, 2005

(54) Collision accident simulator and collision accident simulation method

(75) Inventor: Keiko Nagata, Mie (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TN CORPORATION, Yokkaichi-shi (JP)

(21) Appl. No.: 10/926,388

(22) Filed: Aug. 26, 2004

(30) Foreign Application Priority Data
Jan. 15, 2004 (JP) 2004-8122

(51) Int. Cl. G01M 19/00

(52) U.S. Cl. 73/865.3

(57) ABSTRACT

A collision accident simulator is composed of a vehicle for driving on a predetermined drive road and a collision object for moving in an intersectional direction for a driving direction of the vehicle and colliding with the vehicle. A collision accident simulation method for simulating a simulation collision accident is comprised of steps of riding an experience person for experiencing the simulation collision accident on any of the vehicle and the collision object and making the collision object collide with the vehicle, wherein the vehicle drives on the predetermined drive road.

### BACKGROUND OF THE INVENTION

1. Field of the Invention

The present invention relates to a collision accident simulator and a collision accident simulation method for making a vehicle collide with a collision object.

2. Description of the Related Art

Conventionally, as an apparatus for making a vehicle collide, is known a collision apparatus of the vehicle that drives the vehicle on a predetermined guide rail and makes it collide laterally (for example, see paragraph 0012 and FIG. 1 in Japanese Patent Laid-Open Publication No. 2001-147173 (hereinafter referred to as patent document 1)) or head-on with a wall. The collision apparatus is an actual vehicle safety performance apparatus for actually making an automobile collide with a wall and testing its safety.

In addition, in such the collision apparatus is also known a collision test apparatus for mounting a dummy doll and implementing a collision test from a viewpoint of securing passenger's safety at the time of a collision (for example, see paragraphs 0027 to 0029 and FIGS. 1 to 5 in Japanese Patent No. 3207507 (hereinafter referred to as patent document 2)).

In addition, conventionally as an apparatus for letting common people know a shock strength of a traffic accident, is known an apparatus where a person for experiencing a simulation traffic accident takes a seat at a driver's seat of an automobile, is directly hit on his/her face with an airbag unfolding from a steering wheel, and thereby experiences terribleness of the traffic accident (for example, see paragraphs 00035 to 00037 and FIG. 7 in Japanese Patent Laid-Open Publication No. Hei 10-20764 (hereinafter referred to as patent document 3)).

However, such the collision apparatus disclosed in the patent document 1 is an actual vehicle safety performance apparatus for testing vehicle safety and differs from a traffic accident simulator where an automobile simulates a traffic accident for collision objects such as a colliding pedestrian and a two-wheeled vehicle. Therefore, such the collision apparatus can not heighten self-defense knowledge of a pedestrian and a driver of a collided side for the traffic accident and a conscious mind therefor and cultivate manner-up in a road traffic. Accordingly, such the actual vehicle safety performance apparatus cannot reduce occurrences of traffic accidents.

In addition, the dummy doll disclosed in the patent document 2 is a pseudo-passenger for the purpose of protecting a passenger when an automobile causes a collision accident, is a part of a test apparatus for improving safety of a vehicle-body structure, and cannot contribute to reduce the occurrences of the traffic accidents same as in the patent document 1.

An automobile collision simulation experience apparatus of the patent document 3 is an apparatus whose purposes are that: a driver experiences a state of an airbag for simultaneously unfolding at a shock of an automobile collision in advance; thereby he/she can be made to coolly and collectedly behave in a case of an emergent traffic accident; and his/her traffic safety conscious mind is heightened. However, even if the automobile collision simulation experience apparatus can realize to let a vehicle gotten on, where an airbag is mounted for the prevention of an injury in a case of a collision accident, and heighten the conscious mind of always fastening a seat belt in driving, it cannot contribute to reduce the occurrences of the traffic accidents same as in the patent document 1.

Thus each apparatus of the patent documents 1 to 3 is a safety apparatus and an experience apparatus for an automobile and its driver of a so called perpetrator, is not a safety apparatus for traffic weak such as a pedestrian and cyclist that may become a so called victim, and is also not an apparatus for contributing to reduce the occurrences of the traffic accidents. Therefore, there is a problem that these apparatuses cannot reduce the occurrences of the traffic accidents and injured people due to them.

Generally as a means for reducing traffic accidents, there are a lecture class of traffic safety, a crack-down of a violator of a traffic rule by police, and the like. And as an opportunity of an automobile driver learning the traffic rule and knowing a misery of the traffic accidents, there are the lecture class of the traffic safety, a driver's license lecture class attended in a renewal of a driver's license, and the like. In these lecture classes, there is a problem that the traffic accidents are not reduced because contents of the classes are limited to an explanation and lecture of the traffic rule by a lecturer, a movie, and the like; thereby the automobile driver results in not being experienced through his/her body; and thus his/her conscious mind of having to observe the traffic rule is not heightened.

Consequently, it is important to let a road user know destruction and a shock force in a case of an automobile encountering a traffic accident, a misery in a case of traffic weak such as a pedestrian and a cyclist encountering the traffic accident, and a manner on a road; and to thereby heighten his/her conscious mind of safely driving and walking on the road.

And a danger always accompanies the road and there is a high possibility that the traffic accident occurs. It is important for the road user to know through a simulation experience in advance what occurs to an automobile, a pedestrian, and a bicycle in question in actually encountering the traffic accident and thus always have the conscious mind of the traffic safety of not causing the traffic accident as well as not making it caused.

Therefore, it is desired to further heighten the conscious mind of the road user for the traffic safety and thereby reduce the occurrences of the traffic accidents.

Consequently, is strongly requested a collision accident simulator and a collision accident simulation method that enable an experience of a simulation collision accident between a vehicle and a collision object consisting of any of a pedestrian, a two-wheeled vehicle, and the like.

### SUMMARY OF THE INVENTION

In order to solve the problem described above, a first aspect of the present invention is a collision accident simulator comprising a vehicle, which drives on a predetermined drive road at a desired vehicle speed, and a collision object, which moves in an intersectional direction for a driving direction of the vehicle and collides with it.

In accordance with the first aspect of the present invention, because the collision accident simulator moves in the intersectional direction for the vehicle driving on the predetermined drive road at the desired vehicle speed, an accident can be repeated in simulation like a traffic accident actually caused. Showing the simulation of a collision accident caused by such the collision accident simulator, for example, to traffic safety lecture class members, it can be made to let them visually perceive a situation that the collision object is far dashed off and destroyed by the vehicle in the simulation collision accident.

Thus, when the traffic safety lecture class members actually encounter the traffic accident, they can replace the collision object with themselves and confirm how remarkable damage to themselves is. In accordance with the simulation collision accident the traffic safety lecture class members become able to easily understand that they can dispense with damage, acute aches and injuries to their bodies in really encountering a traffic accident, and may die in some cases. Therefore, the collision accident simulator makes the traffic safety lecture class members feel like not encountering the traffic accident, becomes able to remind them of their naturally confirming safety and “a vehicle is terrible,” and thus can remind them of a self-defense for their not encountering the traffic accident. The collision accident simulator can prevent occurrences of the traffic accidents and contribute to reduce them by reminding the traffic safety lecture class members of such the safety.

A second aspect of the present invention is the collision accident simulator of the first aspect that comprises a collision object movement apparatus, which comprises a support pillar vertically provided at a road side of the drive road, a rail member orthogonally provided for the drive road at a higher position of the support pillar than the vehicle, a hanger member for hanging the collision object from the rail member, and a movement mechanism for moving the hanger member in a transversal direction for the drive road.

In accordance with the second aspect of the present invention the rail member is orthogonally provided for the drive road at the higher position of the support pillar than the vehicle, and thereby the vehicle can be made to drive under the rail member like submerging. Because the hanger member is provided so that the collision object can move forward/backward in the transversal direction, the collision object can be made to run and walk so as to traverse the drive road with being hooked on the hanger member.

Therefore, the collision accident simulator can cause a simulation collision accident, where the collision object for imitating traffic weak such as a pedestrian and a two-wheeled vehicle traversing the drive road collides with a vehicle driving on the drive road. The collision object that has collided with the vehicle is damaged, is dashed off by the vehicle, falls on the ground, and thereby is damaged like a pedestrian in a case of a traffic accident actually caused.

Thus the collision accident simulator can simulate the traffic accident so as to repeat an actually caused collision accident between the vehicle and the traffic weak such as the pedestrian and the two-wheeled vehicle.

A third aspect of the present invention is the collision accident simulator of the second aspect, wherein the collision object is a dummy doll and moves from a road side of the drive road to a center side by the movement mechanism.

In accordance with the third aspect of the present invention the collision accident simulator moves the dummy doll from the road side of the drive road to the center side by the movement mechanism, and thereby the simulator can make the dummy doll hooked on a hanger member automatically walk and thereby imitate any of pedestrians running out into a drive road and walking across the drive road. Therefore, the collision accident simulator can make the dummy doll imitate the pedestrian walking across the drive road for a vehicle driving on the drive road and cause a simulation collision accident. The dummy doll that has collided with the vehicle is damaged, is dashed off by the vehicle, falls on the ground, and thereby is damaged like a pedestrian in a case of a traffic accident actually caused. Thus the collision accident simulator can simulate the traffic accident so as to repeat an actually caused collision accident between the vehicle and the pedestrian.

A fourth aspect of the present invention is the collision accident simulator of the first aspect, wherein the vehicle comprises a guard member at a front portion of a vehicle body for guarding the vehicle body, and wherein the collision object comprises a destructive member for indicating a shock strength at the time of collision of the vehicle at a height position where the guard member collides with the vehicle.

In accordance with the fourth aspect of the present invention the destructive member for indicating the shock strength at the time of collision of the vehicle is provided at the height position where the guard provided at the front portion of the vehicle body member collides with the vehicle, and thereby the shock strength can be indicated according to a destruction degree of the destructive member. For example, the destructive member folds when the shock is small and is destructed as being pulverized when the shock is large. In addition, in a collision accident between a vehicle, which comprises a guard member conforming to a shape of a vehicle body, and a dummy doll, because the dummy doll violently collides with a bonnet portion, a reality of the collision accident can be further heightened.

A fifth aspect of the present invention is the collision accident simulator of the first aspect, wherein the collision object is a two-wheeled vehicle with training wheels.

In accordance with the fifth aspect of the present invention, because the collision object is the two-wheeled vehicle with the training wheels and thereby the two-wheeled vehicle can be kept in a state stood by the training wheels and be made to run, the two-wheeled vehicle can be made to run in simulation as a cyclist actually handles and makes it run. Therefore, the collision accident simulator can make the two-wheeled vehicle run in simulation as a human being runs it, and simulate a traffic accident between the two-wheeled vehicle and an automobile in a state near a reality.

Thus the collision accident simulator can repeat a state where a situation of the two-wheeled vehicle colliding with the automobile is near a reality.

A sixth aspect of the present invention is the collision accident simulator of the first aspect, wherein the collision object comprises a seat for being taken by an experience person, who experiences a simulation collision accident where the vehicle collides with the collision object; a seat belt for constraining the person; and a shock experience carriage for mounting the seat and the seat belt and comprising a carriage stage, under which a plurality of wheels are provided.

In accordance with the sixth aspect of the present invention the collision object comprises the shock experience carriage having the seat, the seat belt, and the carriage stage, whereby it can be made to ride the experience person on the shock experience carriage and run it. Thus it can be made to cause a collision so as to simulate a collision accident between the vehicle and the shock experience carriage at low speed driving. The vehicle collides with the shock experience carriage, thereby the shock experience carriage collides with the vehicle like an actual collision accident and receives a shock force. The experience person who rides on the shock experience carriage is constrained in his/her movement by the seat belt although he/she receives a force moving forward by an inertia force.

Thus the experience person, who rides on the shock experience carriage, makes a light collision with a vehicle driving at a low speed, and can feel by his/her body that a shock is strong even in the collision at the low speed and feel necessity of the seat belt for constraining his/her body in the collision due to a traffic accident when riding on an automobile.

A seventh aspect of the present invention is the collision accident simulator of any of the first to sixth aspects, wherein a seat is placed in the vehicle.

In accordance with the seventh aspect of the present invention the seat is placed in the vehicle, whereby it can be made to make an experience person, who experiences a simulation collision accident of colliding with a collision object, visually perceive a collision situation of the collision object colliding with the vehicle in a state of his/her taking the seat. Thus the collision accident simulator can make the experience person experience the misery of a traffic accident.

An eighth aspect of the present invention is a collision accident simulation method for simulating a simulation collision accident, wherein a collision object is made to collide with a vehicle driving on a predetermined drive road, wherein an experience person is made to ride on any of the vehicle and the collision object, and wherein the vehicle is made to collide with the collision object.

In accordance with the eighth aspect of the present invention the experience person is made to ride on any of the vehicle and the collision object and the vehicle is made to collide with the collision object, whereby he/she can feel a shock force actually burdened on the vehicle by his/her body.

Meanwhile, it is preferable that the support pillar consists of two pieces placed at both sides of left/right of the drive road and is arranged so as to be across the drive road with building the rail member between the two support pillars.

Thus composed, the support pillars are solidly vertically provided for the ground and thereby can hold the rail member without a backlash.

In addition, the destructive member is preferable to be formed of any of wood and a bar member that is easily separable.

Thus composed, because when a vehicle collides, the destructive member is formed of wood and varies in destructive fierceness according to a degree of a shock force and a destruction force received by the wood, the destructive member can indicate the fierceness of the shock according to a destruction degree of the wood.

Furthermore, in the two-wheeled vehicle any of a handle and a front wheel is preferable to be supported in a state of running straightforward by the destructive member.

Thus composed, the two-wheeled vehicle automatically becomes able to run straightforward, and when an automobile collides with the two-wheeled vehicle, the destructive member is destroyed by a shock of the collision and thereby a size of a shock force received thereat by the two-wheeled vehicle can be indicated according to a destruction degree of the destructive member.

### BRIEF DESCRIPTION OF THE DRAWINGS

FIG. 1 is a plan view showing a collision accident simulator and a collision accident simulation method related to a first embodiment of the present invention.

FIG. 2 is a front view showing the collision accident simulator and the collision accident simulation method related to the first embodiment of the present invention.

FIG. 3 is a side view showing the collision accident simulator and the collision accident simulation method related to the first embodiment of the present invention.

FIG. 4 is an enlarged section view of part A of FIG. 2.

FIG. 5 is a drawing showing the collision accident simulator and the collision accident simulation method related to the first embodiment of the present invention and is a block diagram showing a structure of a movement mechanism.

FIG. 6 is a flowchart showing an operation of the collision accident simulator and the collision accident simulation method related to the first embodiment of the present invention.

FIG. 7 is a plan view showing a collision accident simulator and a collision accident simulation method related to a second embodiment of the present invention.

FIG. 8 is a front view showing the collision accident simulator and the collision accident simulation method related to the second embodiment of the present invention.

FIG. 9 is a side view showing the collision accident simulator and the collision accident simulation method related to the second embodiment of the present invention.

FIG. 10 is a drawing showing the collision accident simulator and the collision accident simulation method related to the second embodiment of the present invention and is an enlarged side view of a two-wheeled vehicle.

FIG. 11 is a drawing showing the collision accident simulator and the collision accident simulation method related to the second embodiment of the present invention and is a block diagram showing a structure of a movement mechanism.

FIG. 12 is a flowchart showing an operation of the collision accident simulator and the collision accident simulation method related to the second embodiment of the present invention.

FIG. 13 is a front view showing a collision accident simulator and a collision accident simulation method related to a third embodiment of the present invention.

FIG. 14 is a plan view of a substantial part showing the collision accident simulator and the collision accident simulation method related to the third embodiment of the present invention.

FIG. 15 is a side view of a substantial part showing the collision accident simulator and the collision accident simulation method related to the third embodiment of the present invention.

FIG. 16 is a flowchart showing an operation of the collision accident simulator and the collision accident simulation method related to the third embodiment of the present invention.

FIG. 17 is a plan view showing a collision accident simulator and a collision accident simulation method related to a fourth embodiment of the present invention.

FIG. 18 is a side view showing the collision accident simulator and the collision accident simulation method related to the fourth embodiment of the present invention.

FIG. 19 is an enlarged front view of an automobile for use in the collision accident simulator and the collision accident simulation method related to the fourth embodiment of the present invention.

FIG. 20 is an enlarged front view of a shock experience carriage for use in the collision accident simulator and the collision accident simulation method related to the fourth embodiment of the present invention.

FIG. 21 is a flowchart showing an operation of the collision accident simulator and the collision accident simulation method related to the fourth embodiment of the present invention.

FIG. 22 is a side view of a substantial part showing a collision accident simulator and a collision accident simulation method related to a fifth embodiment of the present invention.

FIG. 23 is a front view showing the collision accident simulator and the collision accident simulation method related to the fifth embodiment of the present invention.

FIG. 24 is a plan view showing the collision accident simulator and the collision accident simulation method related to the fifth embodiment of the present invention.

FIG. 25 is a side view showing a collision accident simulator and a collision accident simulation method related to another embodiment of the present invention.

FIG. 26 is a plan view showing the collision accident simulator and the collision accident simulation method related to the another embodiment of the present invention.

FIG. 27 is an enlarged front view showing the collision accident simulator and the collision accident simulation method related to the another embodiment of the present invention.

### DESCRIPTION OF THE PREFERRED EMBODIMENTS

### First Embodiment

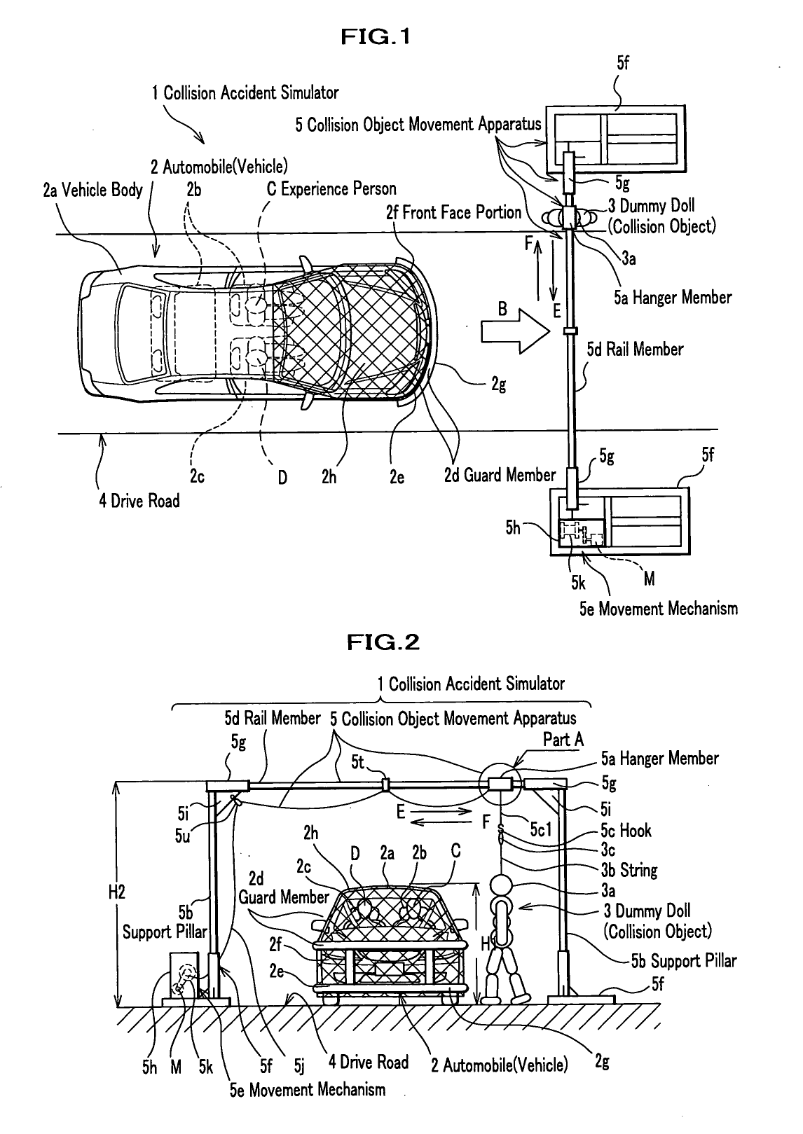

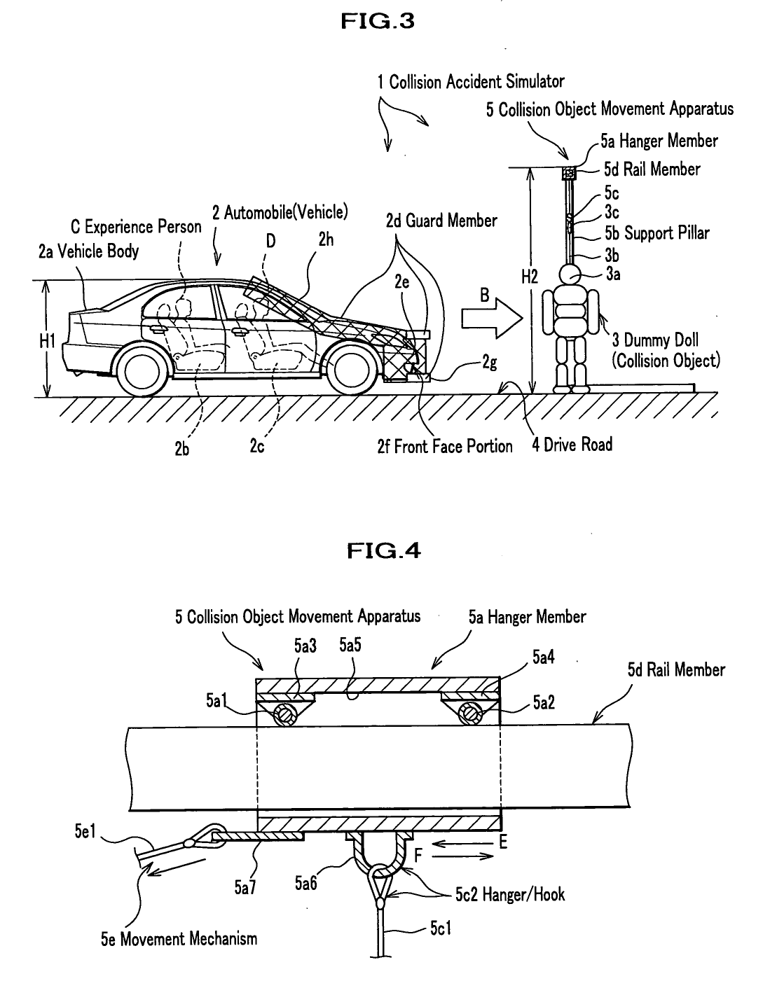

First will be described a collision accident simulator and a collision accident simulation method related to a first embodiment of the present invention, referring to FIGS. 1 to 6. Meanwhile, in the embodiment a “front” means a forward direction of a vehicle, a “rear” means a backward direction of the vehicle, and a “left/right” means a lateral direction of the vehicle.

As shown in FIGS. 1 to 3, a collision accident simulator 1 is an apparatus for simulating a traffic accident where an automobile 2 driving on a drive road 4 and a dummy doll 3 of an imitation pedestrian running out into the drive road 4 collide. The collision accident simulator 1 comprises the automobile 2 driving on the predetermined drive road 4, the dummy doll 3 that moves in an intersectional direction for a driving direction of the automobile 2 and imitates a pedestrian colliding with the automobile 2, and a collision object movement apparatus 5 for moving the dummy doll 3.

The automobile 2 shown in FIGS. 1 to 3 is comprised of a vehicle, which makes any of a commonly used gasoline engine, diesel engine, hybrid engine, and electric motor as a driving source and drives straightforward (a direction of an arrow mark B) on the drive road 4 at a set vehicle speed (for example, 40 km/h). Although a vehicle body 2a of the automobile 2 is, for example, a passenger car type, the type is not specifically limited thereto and a one-box type and the like are also available. The automobile 2 comprises seats 2b for an experience person C, who experiences a simulation traffic accident by the collision accident simulator 1, taking a seat; a driver's seat 2c for a trainer D, who drives the automobile 2 and lectures the simulation traffic accident, taking a seat; guard members 2d that are provided at a front face portion 2f of the vehicle body 2a and guard the vehicle body 2a.

At the front face portion 2f of the vehicle body 2a are placed the guard members 2d consisting of a bumper guard member 2g and a covering body 2h.

The bumper guard member 2g is, for example, made of a rectangle-tubular steel pipe and the like and is placed along up/down of a front face of a bumper 2e.

The covering body 2h is, for example, made of a steel network and the like, which are stretchingly provided so as to have an elasticity, and is arranged so as to cover a bonnet and a front glass of the front face of the vehicle body 2a. The covering body 2h comprises an elasticity and strength so as to recoil the dummy doll 3 when it collides. The covering body 2h may be provided so as to be stretched to a frame body and a skeleton body.

Meanwhile, the automobile 2 may also be a vehicle driving on a rail track provided on the drive road 4 at a predetermined speed like an electric car and a cable car, and a mechanism for driving the automobile 2 and a type of the vehicle body 2a are not specifically limited.

The dummy doll 3 shown in FIG. 2 is formed, for example, imitating a shape of a human being, and is comprised of a doll formed into a size and weight of an adult. The dummy doll 3 is composed, for example, of a head portion 3a, a neck, a trunk of the body, arms having elbow joints, and leg portions having knee joints and feet, and has a skeleton comprising wood and the like within the body thereof. In the dummy doll 3, on a top of the head portion 3a is provided a string 3b for hooking the dummy doll 3 on a hook 5c provided at a hanger member 5a of the collision object movement apparatus 5, in order to hold the dummy doll 3 in such a state that a pedestrian walks upright.

On a top of the string 3b there is a hook portion 3c, and the hook portion 3c is hooked on the hook 5c so that the dummy doll 3 can walk upright in a state that the feet of the dummy doll 3 reach the drive road 4. The hook portion 3c is formed so as to automatically tear loose from or be separated from the hook 5c when a collision force of the automobile 2 is burdened on the dummy doll 3.

Meanwhile, the string 3b may be anything that can hang the dummy doll 3; and a rope, a wire, a chain, and the like are also available.

The drive road 4 shown in FIG. 1 is a simulation road where the automobile 2 drives and the dummy doll 3 traverses and which road is placed at any of an outdoor and an indoor. At road sides of the drive road 4, like a gate striding it, is provided the collision object movement apparatus 5 for moving the dummy doll 3 so as to traverse the drive road 4.

The collision object movement apparatus 5 is an apparatus for moving the dummy doll 3 so as to traverse the drive road 4 in an upright state. The collision object movement apparatus 5 comprises support pillars 5b vertically provided at the road sides of the drive road 4, a rail member 5d orthogonally provided for the drive road 4 at a position H2 of the support pillars 5b higher than a height H1 of the automobile 2, the hanger member 5a for hanging the dummy doll 3 from the rail member 5d, and a movement mechanism 5e for moving the hanger member 5a in transversal directions for the drive road 4, and a runner 5t that is freely slidably placed around the rail member 5d and supports a traction rope 5j connected to the rail member 5d.

The hanger member 5a is a member for hanging the dummy doll 3 from the rail member 5d through the hanger/hook 5c2 and is freely movably fitted around the rail member 5d. The hanger member 5a is formed, for example, any of a metallic member and a synthetic resin whose section is rectangle-tubular. In the hanger member 5a, as shown in FIG. 4, at a top within an opening are provided roller members 5a1 and 5a2 for rolling on an upper face of the rail member 5d, and they are placed so as to be able to smoothly move the rail member 5d. On a lower face of the hanger member 5a, by welding and the like, are fixed an attachment fitting 5a6 for attaching an extension rope 5c1 and a connection fitting 5a7 for connecting the traction rope 5j for pulling the hanger member 5a.

In the roller members 5a1 and 5a2 each of roller attachment seats 5a3 and 5a4 is attached to an inner ceiling face 5a5 of the hanger member 5a by any of welding, a screw fixation, and the like. The roller members 5a l and 5a2 and the roller attachment seats 5a3 and 5a4 are formed of any of a metal and a synthetic resin. The attachment fitting 5a6 and the connection fitting 5a7 are formed, for example, of a metal such as steel and into a U-shape.

The support pillars 5b are vertically placed at both sides of left/right of the drive road 4, are pillars for supporting the rail member 5d from both ends of left/right, and are formed of a metal such as steel. Each of the support pillars 5b of the left/right is H2 in height thereof, is formed higher than the height H1 of the automobile 2 driving on the drive road 4, and thereby is formed so that the automobile 2 can submerge into the drive road 4 under the rail member 5d. At lower ends of the support pillars 5b are provided pedestals 5f by welding so as not to fall down; and at tops of the support pillars 5b are provided rail hold members 5g by welding where both ends of the rail member 5d are inserted, respectively. The pedestals 5f are formed of comparatively a heavy plate member in order to support the support pillars 5b in a stable state and thereat a control box 5h of the movement mechanism 5e is placed. Meanwhile, at one end of the pedestals 5f toward which the automobile 2 drives may be placed a plate for imitating a wall and a fence and making the experience person C and the trainer D unable to see the dummy doll 3, and thereby the drive road 4 may be imitated to be a bad perspective road.

The rail hold members 5g are members where both ends of the rail member 5d are inserted, respectively, and members or holding the rail member 5d on the tops of the support pillars 5b, and for example, are formed of a rectangle-tubular metal with respective bottoms. The rail hold members 5g direct respective openings (not shown), where the rail member 5d is inserted, toward a side of the drive road 4 and are horizontally fixed for the drive road 4 by welding and the like. Between the rail hold members 5g and the support pillars 5b are respectively provided reinforcement members 5i for squarely maintaining both and fixing them by welding. At one reinforcement member 5i of side of the control box 5h is placed a rope guide u for supporting the traction rope 5j.

The rail member 5d supports the hanger member 5a, is a member for guiding a direction where the hanger member 5a moves, and for example, is formed of a metallic block whose section is rectangular. The rail member 5d is provided between the tops of the left/right support pillars 5b through the rail hold members 5g. At the rail member 5d is provided the hanger member 5a for moving the dummy doll 3 in the transversal directions for the drive road 4.

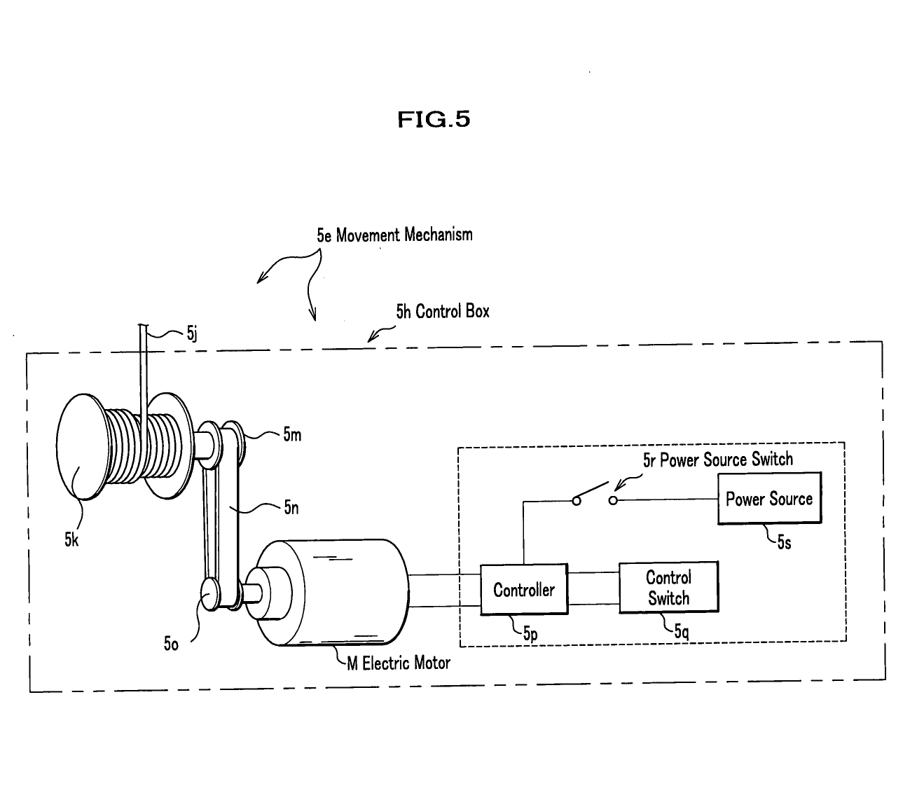

The movement mechanism 5e is a mechanism for moving the hanger member 5a from a road side to center side of the drive road 4 along the rail member 5d and, for example, comprises the traction rope 5j tied to the hanger member 5a and an apparatus for pulling the traction rope 5j and thereby moving the hanger member 5a. As shown in FIG. 5, for example, the movement mechanism 5e comprises the traction rope 5j, a bobbin 5k for winding the traction rope 5j, a driven pulley 5m coaxially provided with the bobbin 5k, a belt 5n for transmitting a rotation of an electric motor M to the driven pulley 5m, a drive pulley 5o for rotating the belt 5n, the electric motor M for rotating the drive pulley 5o, a controller 5p for controlling a rotation speed of the electric motor M, a control switch 5q for setting the rotation speed of the electric motor M in order to move the hanger member 5a at a desired speed, a power source 5s for activating the controller 5p and the electric motor M, and a power source switch 5r for making the movement mechanism 5e ON/OFF.

Meanwhile, the movement mechanism 5e may also be designed to manually pull the traction rope 5j.

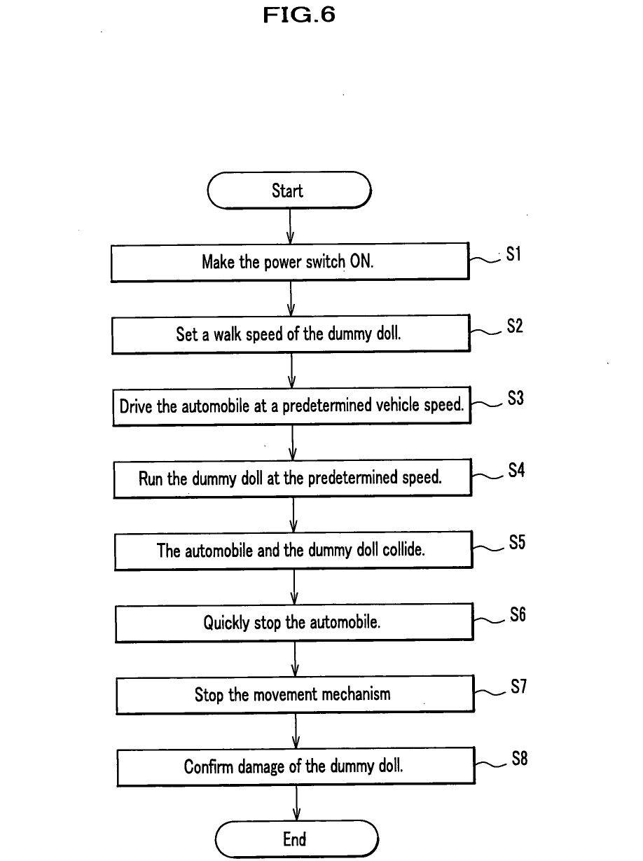

Next will be described an operation of the collision accident simulator and the collision accident simulation method, mainly using FIG. 6 and appropriately referring to other drawings.

First, as shown in FIG. 2, unwind and send out the traction rope 5j from the bobbin 5k, and move the hanger member 5a to a side of the drive road 4 in a direction of an arrow mark F. Next, hook the string 3b of the dummy doll 3 on the hook 5c hanging from the hanger member 5a. And the trainer (driver) 5D and the experience person C get on the automobile 2 and fasten seat belts (not shown). Here, a preparation is completed (start).

Next, make the power source switch 5r of the control box 5h ON (step S1) and set a walk speed of the dummy doll 3, for example, a predetermined speed of 4 km/h (speed of a human being walking) (step S2).

Subsequently, drive the automobile 2 on the drive road 4 at a predetermined speed (for example, 40 km/h) (step S3). Matching a driving of the automobile 2, make the control switch 5q ON. Whereat the electric motor M is driven, rotates the bobbin 5k through the drive pulley 5o, the belt 5n, and the driven pulley 5m, thereby pulls the traction rope 5j, and makes the dummy doll 3 hooked on the hanger member 5a walk to the center side at the predetermined speed (for example, 4 km/h) in such a state that a pedestrian walks (step S4). The dummy doll 3 is hooked on the hanger member 5a through the hanger/hook 5c2 and the like, moves in a horizontal direction for the drive road 4 at the predetermined speed, and thereby imitates a human pedestrian walking upright.

Whereat the automobile 2 collides with the dummy doll 3 running out into the drive road 4 (step S5). After the collision the trainer (driver) D instantly brakes and quickly stops the automobile 2 (step S6) as well as the movement mechanism 5e (step S7).

When colliding with the automobile 2, first the dummy doll 3 collides with the guard members 2d while emitting a collision sound, after then hits the covering body 2h on the bonnet, the front glass, and the like, is dashed off, and falls on the ground.

The experience person C has watched forward the automobile 2 and thereby can visually perceive appearances of: an instant when the dummy doll 3 collides; the dummy doll 3 colliding with the vehicle body 2a such as the guard members 2d and flying away; the trunk, arms and feet, neck, joints, and the like of the dummy doll 3 being folded, and the dummy doll 3 falling on the ground, together with the collision sound.

Then the experience person C and the trainer D get off the automobile 2 and confirm the damage of the dummy doll 3. The experience person C confirms (step S8) the folded appearance of joint places such as the trunk and arms/feet of the dummy doll 3, which has encountered the simulation collision accident, and thereby can experience a misery when a pedestrian collides with the automobile 2 (end).

The experience person C causes the simulation collision accident in accordance with the collision accident simulator 1 by the automobile 2 on which he/she rides; feels by his/her body with seeing the accident straightforward; visually perceives the appearances and damage of the dummy doll 3 at the time of the collision; and becomes able to understand that a danger always tags on a road, there is a possibility of a traffic accident occurring, and thereby the road is dangerous, and what happens to a pedestrian who encounters the traffic accident. Through the experience, the experience person C understands the destruction force of the automobile 2, the misery of the pedestrian due to the traffic accident, a road's user having to always drive safely, an importance of manner-up of the road's user, and the road's user at least observing a traffic rule; and thereby the conscious mind of the experience person C can be heightened so as not to cause the traffic accident. Therefore, the collision accident simulator 1 can contribute to the reduction of the traffic accidents.

### Second Embodiment

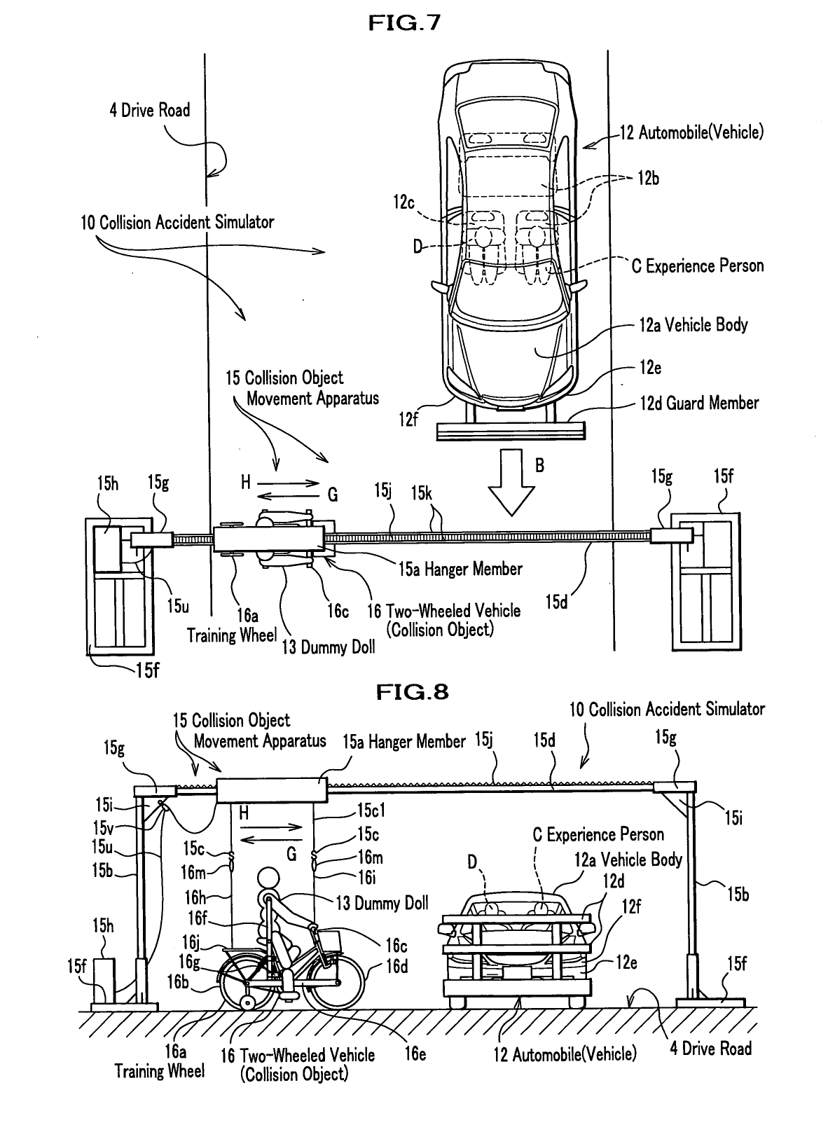

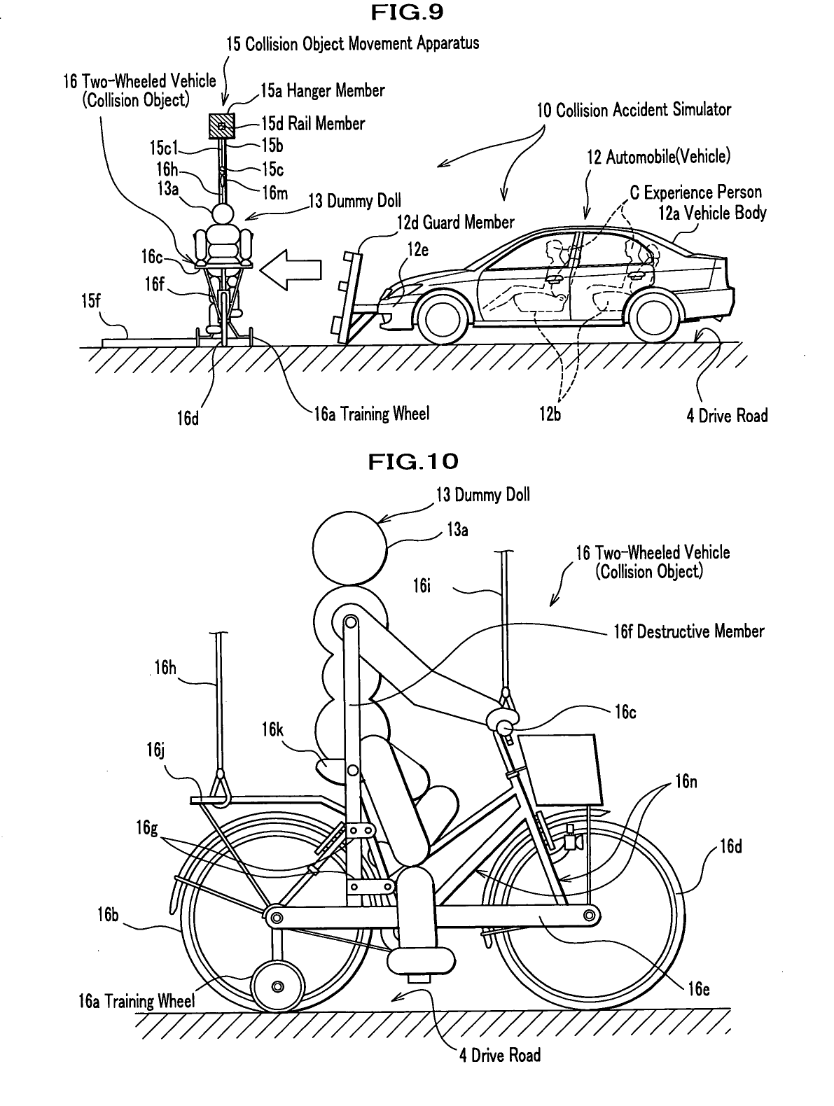

Next will be described a collision accident simulator and a collision accident simulation method related to a second embodiment of the present invention, referring to FIGS. 7 to 12. The second embodiment is the collision accident simulator for simulating a collision accident where a collision object is a two-wheeled vehicle. Meanwhile, for same things as in the first embodiment, same symbols will be appended to the drawings and descriptions thereof will be omitted.

As shown in FIGS. 7 to 9, a collision accident simulator 10 is an apparatus for simulating a traffic accident where an automobile 12 driving on the drive road 4 and a two-wheeled vehicle 16 running out into the drive road 4 collide. The collision accident simulator 10 comprises the automobile 12 driving on the predetermined drive road 4; the two-wheeled vehicle 16, which moves in an intersectional direction for a driving direction of the automobile 12 and collides with the automobile 12; and a collision object movement apparatus 15.

The automobile 12 shown in FIGS. 7 to 9 places guard members 12d consisting of a bumper guard member at a bumper 12e instead of the guard members 2d of the first embodiment (see FIGS. 1 to 3). In the automobile 12 are provided seats 12b for the experience person C, who experiences a simulation traffic accident in accordance with the collision accident simulator 10, taking a seat; a driver's seat 12c for the trainer D, who drives the automobile 12 and lectures the simulation traffic accident, taking a seat; and the guard members 12d that are provided at a front face portion 12f of a vehicle body 12a and guards it.

The guard members 12d are comprised, for example, of a steel material formed like a fence so as to encircle a front face of the vehicle body 12a and are formed into substantially a same length as a vehicle width of the vehicle body 12a in a length of a lateral direction thereof and substantially a same height as that of the seats 12b in a height thereof.

In addition, the automobile 12 may also be a vehicle driving on a rail track provided on the drive road 4 like an electric car and a cable car at a predetermined speed, and a mechanism for driving the automobile 12 and a type of the vehicle body 12a are not specifically limited.

The two-wheeled vehicle 16 shown in FIG. 10 comprises a bicycle, an electric bicycle, an autocycle, and the like, and rides a dummy doll 13 consisting of a same doll as the dummy doll 3 (see FIG. 2) for imitating a pedestrian. The two-wheeled vehicle 16 places training wheels 16a at left/right of a rear wheel 16b for keeping the two-wheeled vehicle 16 in a standing state. In addition, in order to fix a direction of a handle 16c and a front wheel 16d in a straightforward direction, the two-wheeled vehicle 16 fixes, for example, a handle fixation member 16e between the front wheel 16d and the rear wheel 16b. Meanwhile, in order that the two-wheeled vehicle 16 runs straightforward, the handle 16c may be welded. And because a kind of light, a brake lever, a stand, a reflector, and the like have a possibility of scattering away at the time of a collision, they are removed in advance.

In addition, as shown in FIG. 8, in order to run the two-wheeled vehicle 16 in such a state that a human being rides on it, strings 16h and 16i are tied to the handle 16c and a luggage carrier 16j for hooking the two-wheeled vehicle 16 on hooks 15c provided from a hanger member 15a. The two-wheeled vehicle 16 is designed to run on and traverse the drive road 4 by the collision object movement apparatus 15.

Meanwhile, because the two-wheeled vehicle 16 is heavy, it may also be pushed from backward by hands and thus moved in accordance with a situation of the collision object movement apparatus 15 and a road surface situation of the drive road 4.

The dummy doll 13 is supported by a destructive member 16f in a state where the dummy doll 13 takes a seat on a saddle 16k of the two-wheeled vehicle 16. The destructive member 16f shown in FIG. 10 is comprised of a block formed of wood, is destroyed by a shock force caused when the two-wheeled vehicle 16 collides with the automobile 12, and thereby is also a member for indicating a shock strength at the time of the collision. In the destructive member 16f, for example, a center portion thereof is fixed at the saddle 16k, an upper end portion thereof is fixed at the trunk of the dummy doll 13, and a lower end portion thereof is fixed at vehicle body frames 16n through brackets 16g.

Meanwhile, the destructive member 16f may also be designed so as to fix the upper end portion at the trunk of the dummy doll 13, fix the lower end portion at a vehicle axle of the front wheel 16d, and thereby double as the handle fixation member 16e for fixing the handle 16c and the front wheel 16d in a forward direction.

The brackets 16g are, for example, members for fixing the destructive member 16f at the vehicle body frames 16n through a screw fixation and the like, and are formed, for example, of a metallic plate.

In the strings 16h and 16i tied to the two-wheeled vehicle 16 hook portions 16m provided at tops thereof are hooked on the hanger member 15a through the hooks 15c. The two-wheeled vehicle 16 is designed to be kept in an upright state, contacting the drive road 4 through the strings 16h and 16i, be pulled, and thereby be run. When a collision force of the automobile 12 is burdened on the two-wheeled vehicle 16, the hook portions 16m are formed so as to automatically tear loose from or be separated from the hooks 15c.

Meanwhile, the strings 16h and 16i may be anything that can hang the two-wheeled vehicle 16 in a state of its standing and contacting the ground; and a rope, a wire, a chain, and the like are also available.

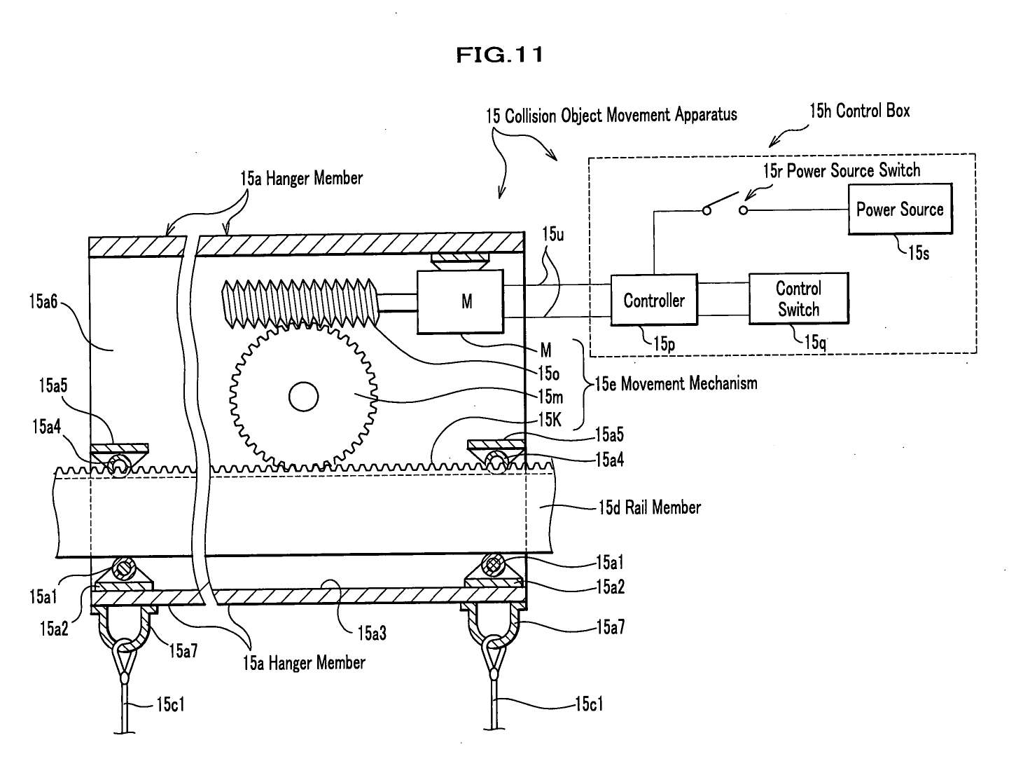

As shown in FIG. 8, the collision object movement apparatus 15 is an apparatus for moving the two-wheeled vehicle 16 so as to traverse the drive road 4 in a standing state. The collision object movement apparatus 15 comprises support pillars 15b; a rail member 15d, where a rack-form gear-tooth portion 15j for engaging a gear 15m shown in FIG. 11 is formed on an upper face of the rail member 5d (see FIG. 2) of the first embodiment; the hanger member 15a for hanging the two-wheeled vehicle 16; a movement mechanism 15e for moving the hanger member 15a in the transversal directions for the drive road 4; and a control box 15h for controlling the movement mechanism 15e.

Meanwhile, the support pillars 15b of the collision object movement apparatus 15 are same structures as those of the support pillars 5b (see FIG. 2) of the first embodiment.

The hanger member 15a is a member for hanging the two-wheeled vehicle 16 from the rail member 15d through the hooks 15c and is freely movably fitted around the rail member 15d. The hanger member 15a is formed of a tubular member of substantially the same shape as the hanger member 5a (see FIG. 4) of the first embodiment.

In the hanger member 15a, as shown in FIG. 11, within an opening of a rectangle-tubular in a section thereof are provided roller members 15a1, 15a1, 15a2, and 15a2 for rolling on a lower face of the rail member 15d; roller members 15a4, 15a4, 15a5, and 15a5 for rolling on the upper face of the rail member 15d, and they are placed so as to be able to smoothly move the rail member 15d. On a lower face of the hanger member 15a are fixed attachment fittings 5a7 for attaching an extension rope 15c1 by welding and the like.

The roller members 15a1 are attached to left/right ends of an inner lower face 15a3 of the hanger member 15a by any of welding, a screw fixation, and the like through respective roller attachment seats 15a2. Each of roller attachment seats 15a5 of the roller members 15a4 is attached to an inner sidewall 15a6 of the hanger member 15a by any of welding, a screw fixation, and the like. The roller members 15a1 and 15a4 and the roller attachment seats 15a2 and 15a5 are formed of any of a metal and a synthetic resin.

The movement mechanism 15e shown in FIG. 11 is an apparatus for moving the hanger member 15a from the road side to center side of the drive road 4 along the rail member 15d. The movement mechanism 15e comprises, for example, the gear-tooth portion 15j, the gear 15m for engaging the gear-tooth portion 15j, a deceleration gear 15o for engaging the gear 15m and rotating the electric motor M in deceleration, the electric motor M for rotating the deceleration gear 15o, a controller 15p for controlling a rotation speed of the electric motor M, a control switch 15q for setting the rotation speed of the electric motor M in order to move the hanger member 15a at a desired speed, a power source 15s for activating the controller 15p and the electric motor M, and a power source switch 15r for making the movement mechanism 15e ON/OFF.

The electric motor M within the hanger member 15a is, as shown in FIGS. 8 and 11, electrically connected to the controller 15p within the control box 15h through cords 15u.

Meanwhile, the movement mechanism 15e may also be designed to manually pull the traction rope 5j (see FIG. 2) with tying the traction rope 5j to the hanger member 15a.

Meanwhile, the support pillars 15b, the pedestals 15f, rail hold members 15g, the control box 15h, reinforcement members 15i, and a rope guide 15v shown in FIG. 8 are substantially same as the support pillars 5b, the pedestals 5f, the rail hold members 5g, the control box 5h, the reinforcement members 5i, and a rope guide 5u of the first embodiment shown in FIG. 2, respectively.

The control box 15h is placed on one of the pedestals 15f and, as shown in FIG. 11, comprises the controller 15p, the control switch 15q, the power source switch 15r, and the power source 15s.

As shown in FIG. 8, the rail member 15d supports the hanger member 15a same as the rail member 5d (see FIG. 2) of the first embodiment and is a member for guiding a movement direction of the hanger member 15a. The rail member 15d is arranged between the left/right support pillars 15b and on the upper face thereof along a center line of the rail member 15d are linearly formed planes 15k where the rack-form gear-tooth portion 15j and the roller members 15a4 roll. Around the rail member 15d is freely movably provided the hanger member 15a of the collision object movement apparatus 15 for moving the two-wheeled vehicle 16 in the transversal directions for the drive road 4.

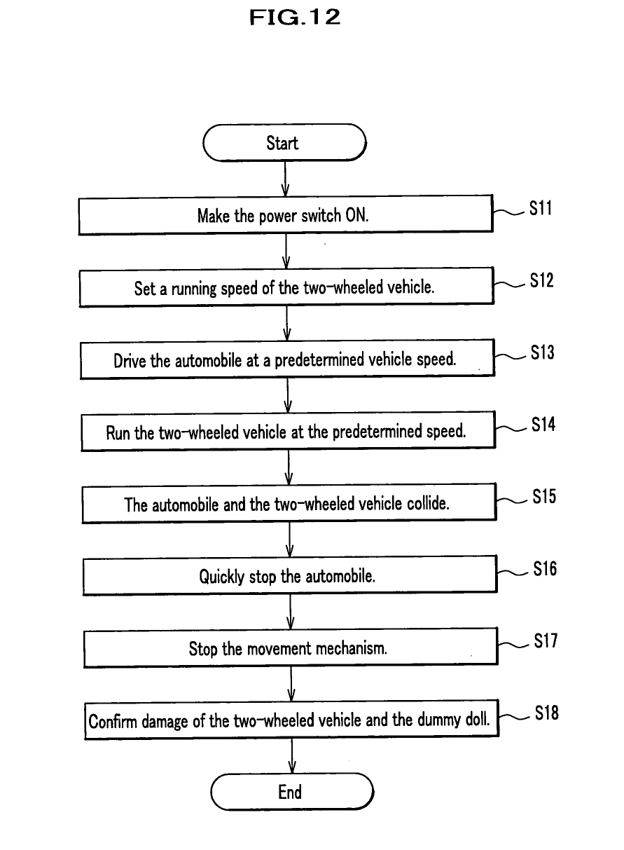

Next will be described a collision accident simulator and a collision accident simulation method of the second embodiment, mainly referring to FIG. 12.

First, as shown in FIG. 8, fix the dummy doll 13 on the two-wheeled vehicle 16 by the destructive member 16f and hook the strings 16h and 16i of the two-wheeled vehicle 16 on the hooks 15c hanging from the hanger member 15a. Then the trainer (driver) D and the experience person C get on the automobile 12 and fasten seat belts (not shown). Here, a preparation is completed (start).

Next, make the power source switch 15r (see FIG. 11) ON (step S11) and move the hanger member 15a to a side of the drive road 4 in a direction of an arrow mark G. Then, set a running speed of the two-wheeled vehicle 16 a predetermined speed (for example, 10 km/h) (step S12).

Subsequently, drive the automobile 12 at a predetermined speed (for example, 40 km/h) on the drive road 4 (step S13). Matching a driving of the automobile 12, make the control switch 15q, shown in FIG. 11, ON. Whereat the electric motor M is driven, rotates the gear 15m through the deceleration gear 15o, thereby moves the hanger member 15a to a center side (a direction of an arrow mark H) of the drive road 4. As shown in FIG. 8, the two-wheeled vehicle 16 hooked on the hanger member 15a runs toward the center side at a speed of 10 km/h (step S14). The two-wheeled vehicle 16 is hooked on the hanger member 15a through the hooks 15c and the like, the hanger member 15a horizontally moves at a predetermined speed for the drive road 4, and thereby the two-wheeled vehicle 16 imitates a bicycle run by a human cyclist.

Whereat the automobile 12 collides with the two-wheeled vehicle 16 running out into the drive road 4 (step S15). After the collision the trainer (driver) D instantly brakes and quickly stops the automobile 12 (step S16) as well as the movement mechanism 15e (step S17).

When colliding with the automobile 12, the two-wheeled vehicle 12 collides with the guard member 12d, is dashed off, and falls on the ground. The destructive member 16f is destroyed by a collision shock; and thereby the dummy doll 13 is separated from the two-wheeled vehicle 16, is thrown out, and falls on the ground.

The experience person C has watched forward the automobile 12 and thereby can visually perceive appearances of: an instant when the two-wheeled vehicle 16 and the dummy doll 13 collide; the two-wheeled vehicle 16 and the dummy doll 13 colliding with the vehicle body 2a such as a bonnet and flying away; the two-wheeled vehicle 16 being destroyed; the trunk, arms and feet, neck, joints, and the like of the dummy doll 13 being folded, and the dummy doll 13 falling on the ground, together with a collision sound.

Then the experience person C and the trainer D get off the automobile 12 and confirm the damage of the two-wheeled vehicle 16 and the dummy doll 13. The experience person C confirms (step S17) a folded appearance of joint places such as the trunk and arms/feet of the dummy doll 13, which has encountered the simulation collision accident, the damage of the overall body and the two-wheeled vehicle 16, and the like, and thereby can experience a misery when the two-wheeled vehicle 16 collides with the automobile 12 (end).

The experience person C feels the simulation collision accident in accordance with the collision accident simulator 10 by his/her body with seeing the accident straightforward; visually perceives the appearances and damage of the two-wheeled vehicle 16 and the dummy doll 13 at the time of the collision; and thereby becomes able to understand that a danger always tags on a road, there is a possibility of a traffic accident occurring, and thereby the road is dangerous, and what happens to the two-wheeled vehicle 16 and dummy doll 13 that encounter the traffic accident. Through the experience, the experience person C understands the destruction force of the automobile 12, the misery of cyclist of the two-wheeled vehicle 16 due to the traffic accident, a road's user having to always drive safely, the importance of manner-up of the road's user, and the road's user at least observing the traffic rule, and thereby the conscious mind of the experience person C can be heightened so as not to cause the traffic accident. Therefore, the collision accident simulator 10 can contribute to the reduction of the traffic accidents.

### Third Embodiment

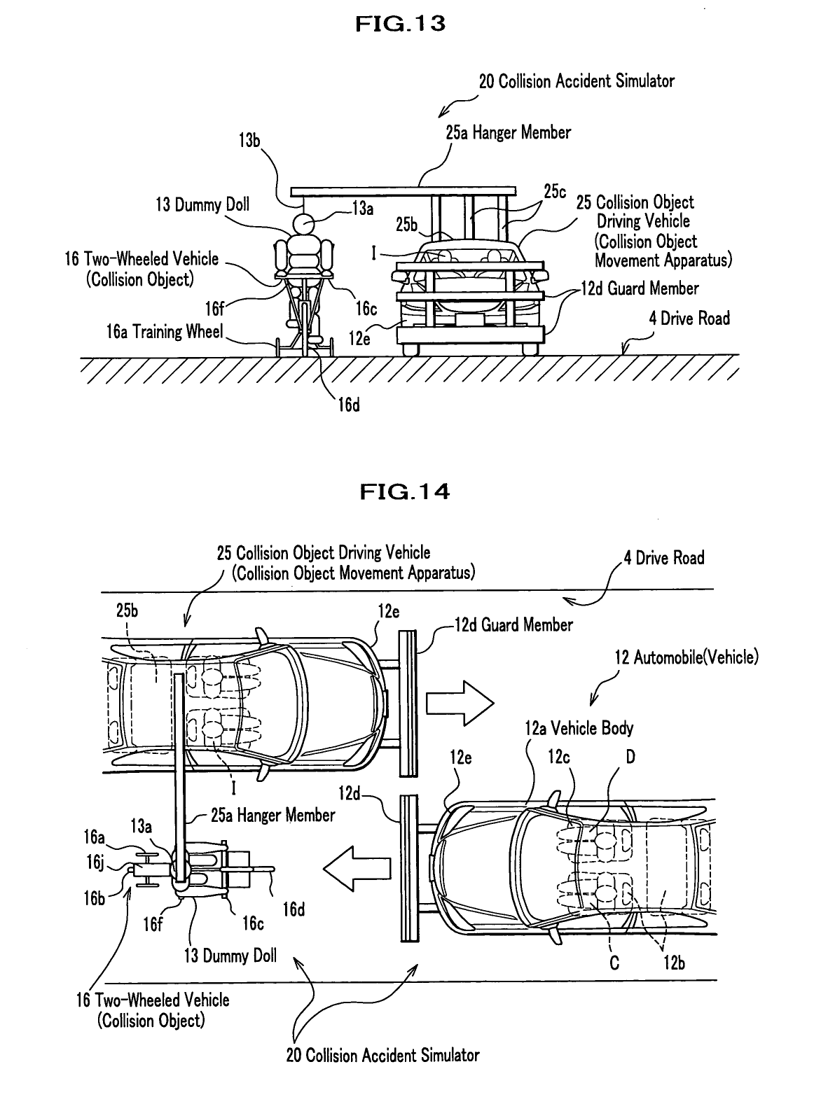

Next will be described a collision accident simulator and a collision accident simulation method related to a third embodiment of the present invention, referring to FIGS. 13 to 16. The third embodiment is the collision accident simulator for running the two-wheeled vehicle 16 (see FIG. 8) of the second embodiment by a collision object driving vehicle and making the two-wheeled vehicle 16 collide head-on. Meanwhile, for same things as in the first and second embodiments, same symbols will be appended to the drawings and descriptions thereof will be omitted.

As shown in FIGS. 13 to 15, a collision accident simulator 20 is an apparatus for simulating a traffic accident where the automobile 12 driving along the drive road 4 and the two-wheeled vehicle 16 running on the drive road 4 in a direction of the automobile 12 collide head-on. The collision accident simulator 20 comprises the automobile 12 for driving on the predetermined drive road 4, the two-wheeled vehicle 16 for moving in a reverse direction for a driving direction of the automobile 12 and colliding with it, and a collision object driving vehicle 25 for driving the two-wheeled vehicle 16 toward the automobile 12.

The two-wheeled vehicle 16 and the dummy doll 13 are substantially same as those of the second embodiment, and the string 13b provided on the head portion 13a of the dummy doll 13 is hooked on a tip portion of a hanger member 25a, which is provided on a roof 25b of the collision object driving vehicle 25. The two-wheeled vehicle 16 is kept in a state stood by training wheels 16a, the string 13b of the dummy doll 13 is hooked on the hanger member 25a of the collision object driving vehicle 25, and thereby the two-wheeled vehicle 16 is designed to be pulled by the collision object driving vehicle 25 and thus be run.

The collision object driving vehicle 25 is a vehicle for moving the two-wheeled vehicle 16 so as to move straightforward in a standing state. In the collision object driving vehicle 25 carriers 25c are attached on the roof 25b of the automobile 2 described in the first embodiment, and the hanger member 25a is provided on the carriers 25c like a one-side support beam. In the collision object driving vehicle 25 a trainer I takes a driver's seat, for example, drives on a right side of the drive road 4 at a vehicle speed of 10 km/h, and thus makes the two-wheeled vehicle 16 run on the left side of the drive road 4 at the same speed.

The hanger member 25a is comprised, for example, of a metallic block like the rail member 5d (see FIG. 2) described in the first embodiment and is fixed on an upper portion of the carriers 25c by welding and the like. The carriers 25c are formed of a metallic member solidly fixed on an upper face of the roof 25b, at a mohican groove portion of a roof panel, on a roof side rail, and the like in the collision object driving vehicle 25.

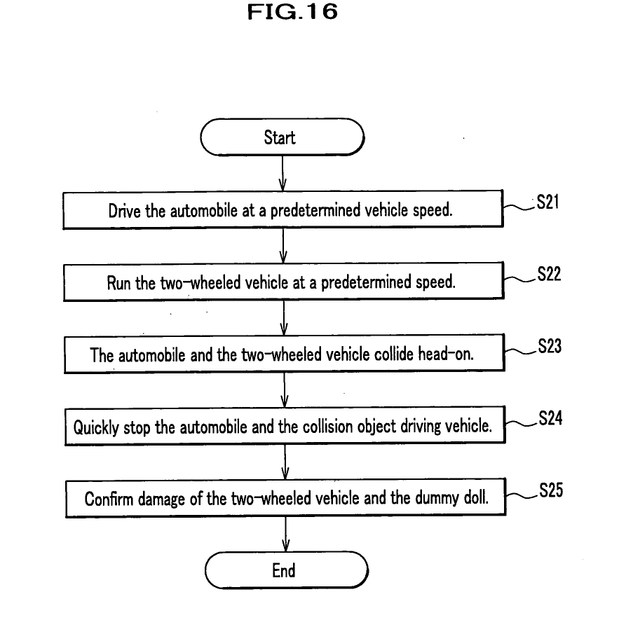

Next will be described an operation of the collision accident simulator and the collision accident simulation method in the third embodiment, mainly using FIG. 16 and appropriately referring to other drawings.

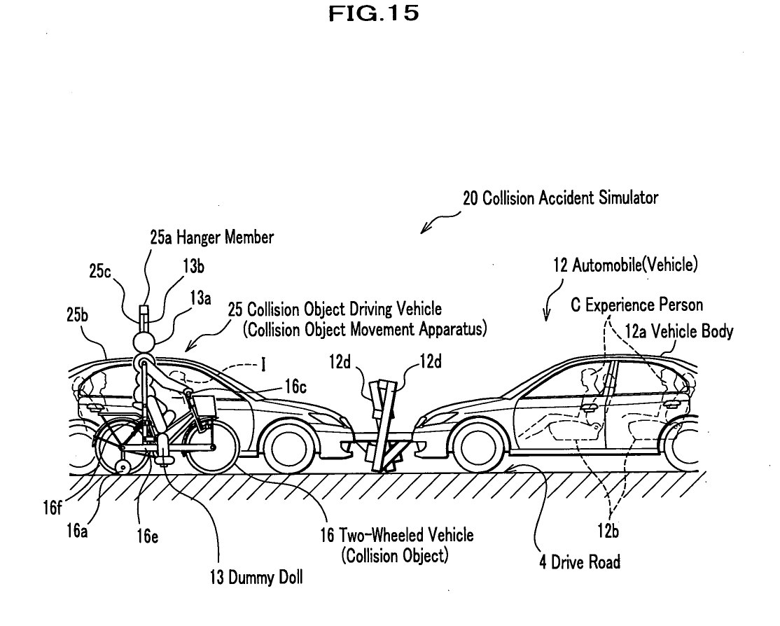

First, as shown in FIG. 15, fix the dummy doll 13 on the two-wheeled vehicle 16 by the destructive member 16f and hook the string 13b of the dummy doll 13 on the hanger member 25a. Then the trainer (driver) I gets on the collision object driving vehicle 25 and fastens a seat belt (not shown). Here, a preparation is completed. On the other hand, the trainer (driver) D and the experience person C get on the automobile 12 and fasten seat belts (not shown). Here, a preparation is completed (start).

Next, drive the automobile 12 on the left side of the drive road 4 at a predetermined speed (for example, 40 km/h) (step S21). Matching the driving of the automobile 12, drive the collision object driving vehicle 25, and thus make the two-wheeled vehicle 16 run on the left side of the drive road 4 at a predetermined speed (for example, 10 km/h) (step S22). Whereat, because the string 13b is hooked on the hanger member 25a, the two-wheeled vehicle 16 is pulled, imitates a bicycle run by a human cyclist, and thus is run at the speed same as the collision object driving vehicle 25.

Then the two-wheeled vehicle 16 collides head-on with the automobile 12 (step S23). After the collision the trainer (driver) D of the automobile 12 instantly brakes and quickly stops the automobile 12; and after the collision the trainer (driver) I of the collision object driving vehicle 25 instantly brakes and quickly stops the collision object driving vehicle 25 (step S24).

When colliding with the automobile 12, the two-wheeled vehicle 16 collides with the guard member 12d, is destroyed, is dashed off, and falls on the ground. The destructive member 16f is destroyed by a collision shock and thereby the dummy doll 13 is separated from the two-wheeled vehicle 16, is thrown out, and falls on the ground.

The experience person C has watched forward the automobile 12 and thereby can visually perceive appearances of: an instant when the two-wheeled vehicle 16 and the dummy doll 13 collides; the two-wheeled vehicle 16 and the dummy doll 13 colliding with the vehicle body 2a such as a bonnet and flying away; the two-wheeled vehicle 16 being destroyed; the trunk, arms and feet, neck, joints, and the like of the dummy doll 13 being folded, and the dummy doll 13 falling on the ground, together with a collision sound.

Then the experience person C and the trainer D get off the automobile 12 and confirm the damage of the two-wheeled vehicle 16 and the dummy doll 13. The experience person C confirms (step S25) a folded appearance of joint places such as the trunk and arms/feet of the dummy doll 13, which has encountered the simulation collision accident, the damage of the overall body and the two-wheeled vehicle 16, and the like, and thereby can experience a misery when the two-wheeled vehicle 16 collides head-on with the automobile 12 (end).

### Fourth Embodiment

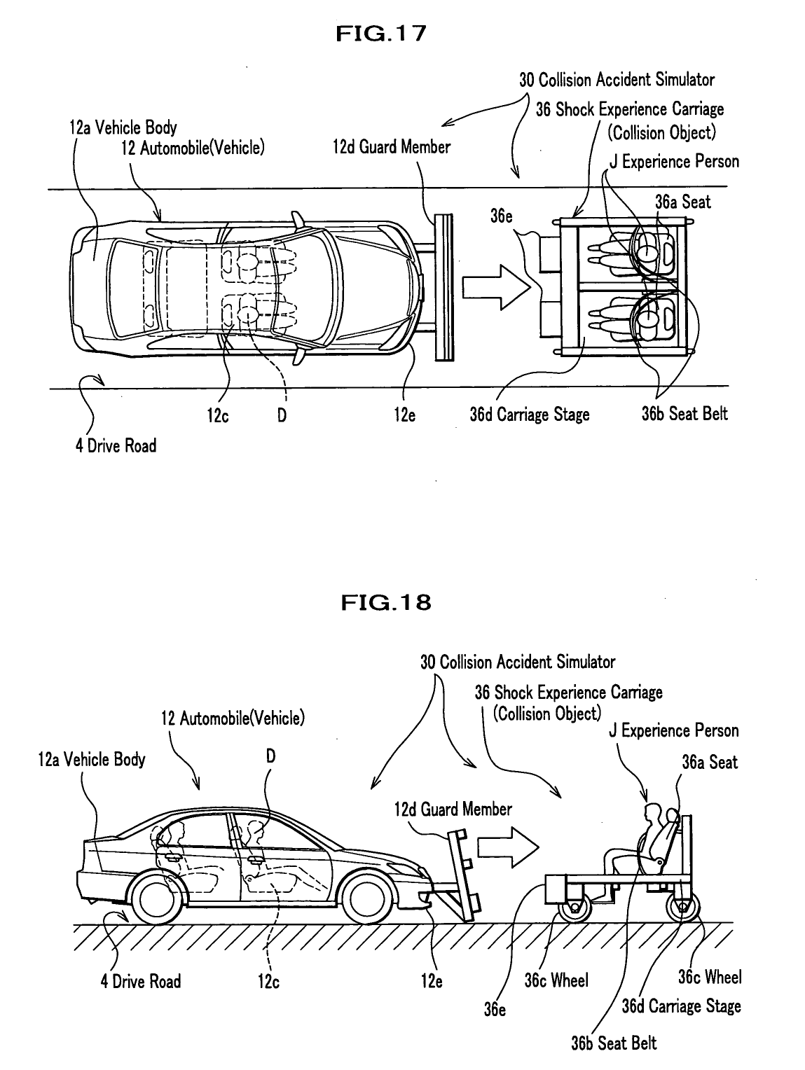

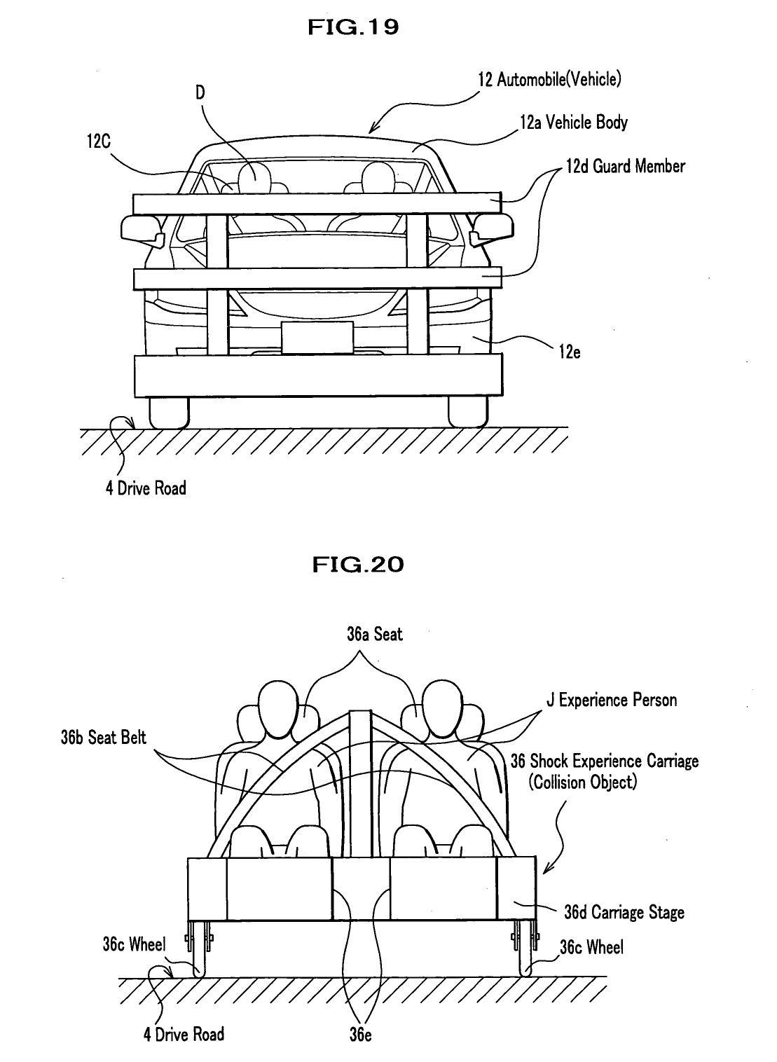

Next will be described a collision accident simulator and a collision accident simulation method related to a fourth embodiment of the present invention, referring to FIGS. 17 to 21. The fourth embodiment is the collision accident simulator where a collision object for colliding head-on with an automobile driving at a low speed is made a shock experience carriage, on which experience persons for experiencing a simulation collision accident get. Meanwhile, for same things as in the first to third embodiments, same symbols will be appended to the drawings and descriptions thereof will be omitted.

As shown in FIGS. 17 to 20, a collision accident simulator 30 is an apparatus for simulating a traffic accident where the automobile 12 driving on the drive road 4 at a low speed collides head-on with a shock experience carriage 36, on which experience persons J get. The collision accident simulator 30 comprises the automobile 12 for driving on the predetermined drive road 4 and the shock experience carriage 36 for lightly colliding with the automobile 12 in a state of any of its being run at a low speed in a reverse direction for a driving direction of the automobile 12 and being stopped.

The shock experience carriage 36 comprises seats 36a for the experience persons J, who experience a simulation collision accident that the automobile 12 collides with the shock experience carriage 36, taking respective seats 36a; seat belts 36b for constraining the experience persons J to the seats 36a; a carriage stage 36d for mounting the seats 36a and the seat belts 36b and providing a plurality of wheels 36c; and a buffer member 36e provided at a front face of the carriage stage 36d. The shock experience carriage 36 is a vehicle that can make the experience persons J take the respective seats 36a and run straightforward on the drive road 4 at a low speed. And for example, the shock experience carriage 36 is designed to be able to be pushed by hands of a human being and thereby be run at the low speed.

The carriage stage 36d is placed at substantially a same height as that of the bumper 12e. And the seats 36a are placed so that view lines of the experience persons J become low, and thereby they can see an instant of a collision with the automobile 12 with their naked eyes. The seats 36a are arranged so that the automobile 12 collides at a position of about 15 cm to about 20 cm from their knees in a state of their taking the respective seats 36a, and thus the shock experience carriage 36 and the automobile 12 collide in a vicinity of the experience persons J.

Meanwhile, the shock experience carriage 36 may be made to be able to run by itself, attaching any of an electric motor and an engine to it.

The shock experience carriage 36 is a vehicle that rides the experience persons J, is left on the drive road 4 in a state of any of its being stopped and being run at a low speed, and lightly collides with the automobile 12. The automobile 12 is a vehicle that drives toward the shock experience carriage 36 on the drive road 4, for example, at a vehicle speed of 8 km/h and collides head-on with it.

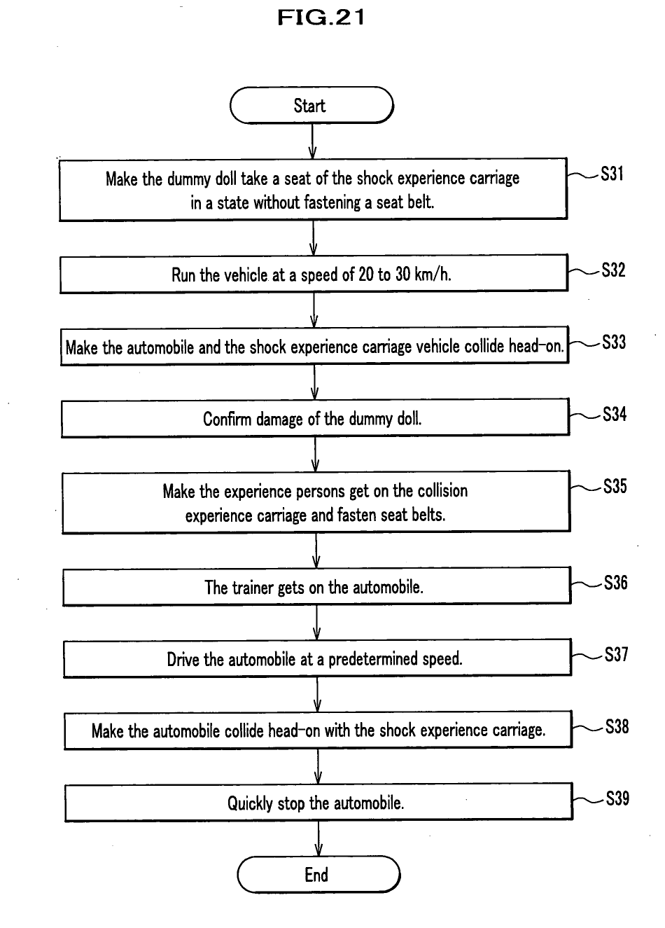

Next will be described an operation of the collision accident simulator and the collision accident simulation method in the fourth embodiment, mainly using FIG. 21 and appropriately referring to other drawings.

First, the trainer D does not ride the experience persons J on the shock experience carriage 36 and explains them of a head-on collision of the automobile 12 and the shock experience carriage 36 (start).

Next, make two dummy dolls 13 (see FIG. 10) of the second/third embodiments take respective seats 36a and ride them in a state of not fastening respective seat belts 36b (step S31).

Then make the shock experience carriage 36 run at a speed of 20 to 30 km/h (step S32) and collide head-on with the automobile 12 stopped (step S33). At this time the dummy dolls 13 are sprung up from the seats 36a at an instant of the collision, are thrown out to a side of the automobile 12, hit the vehicle body 12a, and fall on the ground. The experience persons J can visually perceive appearances of the dummy dolls 13 flying away, hitting the vehicle body 12a, falling on the ground, and the like (step S34).

The trainer I explains the experience persons J that there are a larger shock force and destruction force in an actual head-on collision because a traffic accident due to a general automobile 12 occurs at a speed of not less than 40 km/h.

Subsequently, make the two experience persons J take respective seats 36a of the shock experience carriage 36 and fasten respective seat belts 36b (step S35). The trainer D gets on the automobile 12 and fastens a seat belt (not shown) (step S36).

Next, drive the automobile 12 on the drive road 4 at a predetermined low speed (for example, 8 km/h) (step S37) and make it collide head-on with the shock experience carriage 36 stopped (step S38). The trainer (driver) D instantly brakes and quickly stops the automobile 12 (step S39).

The shock experience carriage 36 receives a shock due to the collision with the automobile 12, is pushed by the automobile 12, and moves backward.

Although the experience persons J receive a shock due to the collision with the automobile 12 and move forward as being pushed out, they have fastened the respective seat belts 36b and thereby constraint states to the respective seats 36a are kept. Thus, even if the vehicle speed of the automobile 12 is the low speed, the experience persons J can feel by their bodies to receive a strong shock force and terribleness of a traffic accident at the time of the head-on collision (end).

The trainer D explains the experience persons J that the vehicle speed of the automobile 12 in accordance with the collision accident simulation method is a low speed of 8 km/h; that of the automobile 12 driving on an open road is 40 km/h, fivefold of 8 km/h; and an actual collision occurs at a speed of 40 km/h. And because in an actual traffic accident the vehicle speed is faster, let the experience persons J understand that the shock force and damage are larger and fastening the respective seat belts 36b is more important.

Meanwhile, when training at a wider place, the automobile 12 in the fourth embodiment may be accelerated from a point of about 50 meters ahead, be quickly decelerated, and be made to collide with the shock experience carriage 36. In addition, when training at a narrower place, the automobile 12 of an automatic vehicle may be made a D (Drive) range and be designed to collide from about 10 meters ahead in a state of idling (creep phenomenon) of no acceleration and no braking.

### Fifth Embodiment

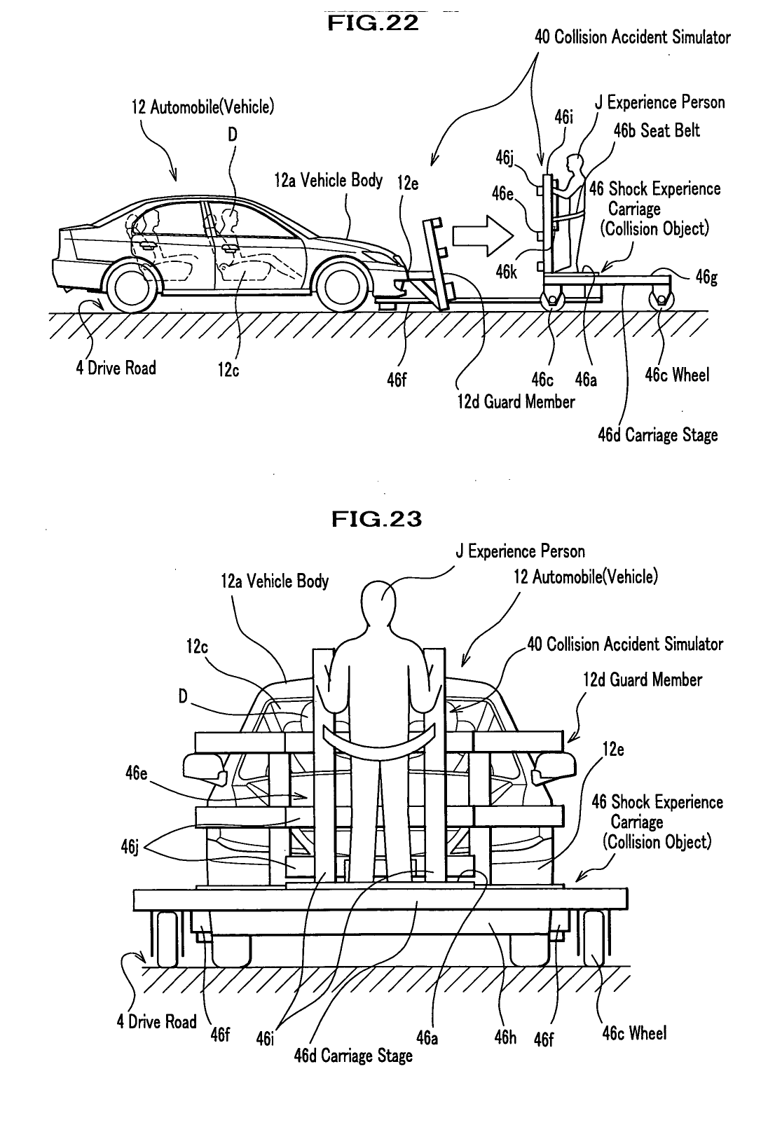

Next will be described a collision accident simulator and a collision accident simulation method related to a fifth embodiment of the present invention, referring to FIGS. 22 to 24. The fifth embodiment is the collision accident simulator where an experience person for experiencing a simulation collision accident gets on the shock experience carriage of the fourth embodiment in a standing state and the carriage collides head-on with an automobile driving at a low speed. Meanwhile, for same things as in the fourth embodiment, same symbols will be appended to the drawings and descriptions thereof will be omitted.

As shown in FIGS. 22 to 24, a collision accident simulator 40 is an apparatus for simulating a traffic accident where the automobile 12 driving on the drive road 4 at a low speed collides head-on with a shock experience carriage 46, on which the experience person J for experiencing a simulation collision accident gets in a standing state. The collision accident simulator 40 comprises the automobile 12 for driving on the predetermined drive road 4 and the shock experience carriage 46 for lightly colliding with the automobile 12 in a state of any of its being run at the low speed in a reverse direction for a driving direction of the automobile 12 and being stopped.

The shock experience carriage 46 is a vehicle that can ride the experience person J in a state of his/her standing on a floor panel 46a and run straightforward on the drive road 4 at the low speed. And for example, the shock experience carriage 46 is designed to be able to be pushed by hands of a human being and thereby be run at the low speed. The shock experience carriage 46 rides the experience person J, is left in a state of any of being stopped on the drive road 4 and being run at the low speed, and lightly collides with the automobile 12. The shock experience carriage 46 comprises the floor panel 46a, on which the experience person J for experiencing a simulation collision accident of the automobile 12 colliding with the carriage 46 gets in a standing state; a seat belt 46b for constraining the experience person J; a passenger protector 46e, which is vertically provided on the front panel 46a at a front end, protects the experience person J from a front face, and which he/she grips; a carriage stage 46d where the floor panel 46a and the passenger protector 46e are placed; four wheels 46c provided under the carriage stage 46d; and protrusions 46f provided forward from left/right ends of the carriage stage 46d.

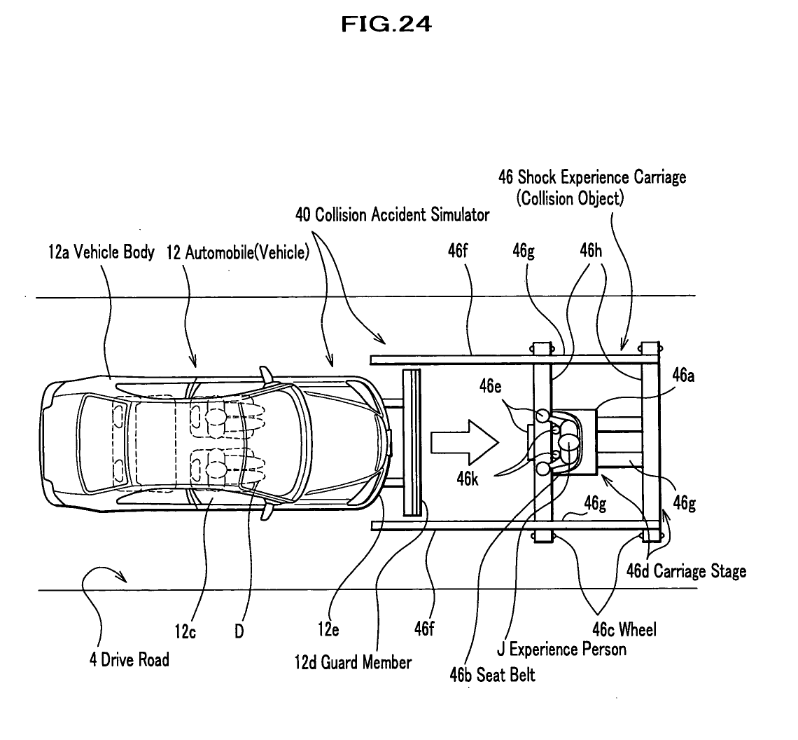

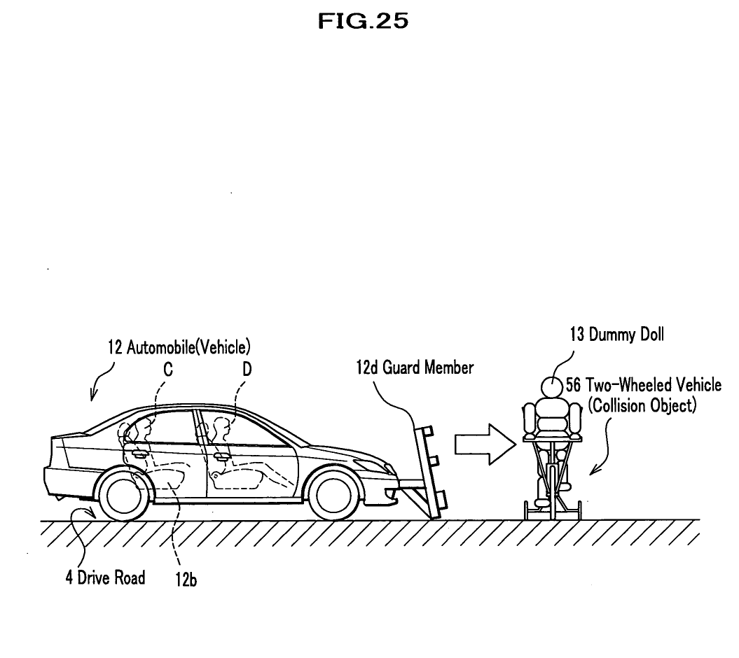

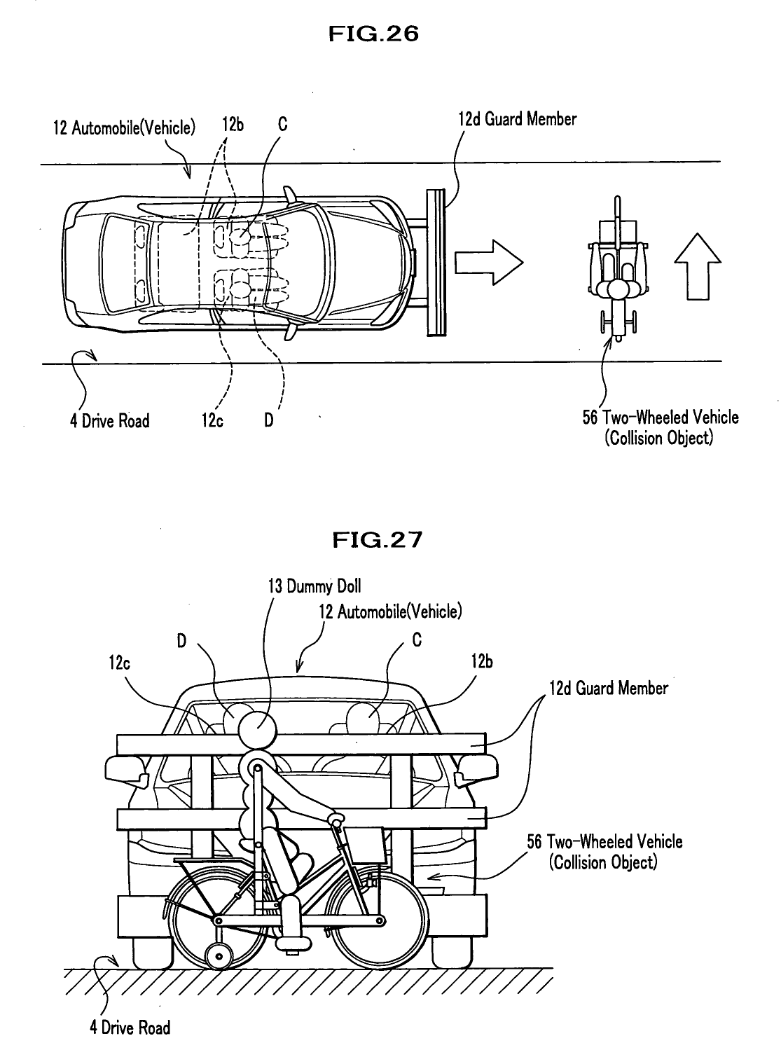

The carriage stage 46d is assembled by welding steel members comprised of such groove-form steel whose section is, for example, rectangular without one side. The carriage stage 46d is, as shown in FIG. 24, arranged in a front/rear direction and comprises side frames 46g where the floor panel 46a is placed and cross frames 47h provided in a vehicle lateral direction for the side frames 46g.

The floor panel 46a is comprised of a metallic plate such as a steel plate provided at a center front end on the carriage stage 46d of a skeleton form and is fixed on the carriage stage 46d by welding and the like.

The passenger protector 46e is assembled, as shown in FIG. 23, by welding steel members comprised of such groove-form steel, whose section is, for example, rectangular without one side, and fixing vertical members 46i and horizontal members 46j substantially like a ladder. The passenger protector 46e is vertically provided on the center front end of the carriage stage 46d, is a little bit lower than the experience person J in a height thereof, and is formed longer than his/her width in a width thereof in a lateral direction. The passenger protector 46e comprises each role of a member for blocking the experience person J to move to a side of the automobile 12, a handle member for the experience person J gripping the passenger protector 46e by hands, a member for placing the seat belt 46b, and a member for placing a cushion 46k.

The vertical members 46i are, as shown in FIG. 23, placed at such a degree of a width distance, where the left/right of breast of the experience person J contact them, respectively, and have the cushion 46k (see FIG. 22) for pushing both shoulders of the experience person J and buffering a shock when the shock experience carriage 46 collides with the automobile 12.

The protrusions 46f are bar-form members for blocking the shock experience carriage 46 to fall forward when the carriage 46 collides with the automobile 12, and are placed at left/right in parallel below the carriage stage 46d at a distance sufficiently wider than a vehicle width of the automobile 12 as shown in FIG. 24.

Next will be described an operation of the collision accident simulator and the collision accident simulation method in the fifth embodiment, referring to FIGS. 22 to 24.

First, as shown in FIG. 22, ride the experience person J on the floor panel 46a of the shock experience carriage 46 and make him/her fasten the seat belt 46b. The trainer (driver) D gets on the automobile 12 and fastens a seat belt (not shown).

Next, drive the automobile 12 on the drive road 4 at a predetermined speed (for example, 8 km/h) and make the automobile 12 collide head-on with the shock experience carriage 46 stopped. After the collision the trainer (driver) D instantly brakes and quickly stops the automobile 12.

The automobile 12 collides with the shock experience carriage 46, thereby the guard member 12d of the automobile 12 collides with the passenger protector 46e, and the shock experience carriage 46 receives an inertia force by which the shock experience carriage 46 and the experience person J are pushed out forward.

At this time the protrusions 46f at the front end of the carriage stage 46d hits a road face of the drive road 4, and thereby the shock experience carriage 46 is blocked to fall down forward.

Although the experience person J receives a shock due to the collision with the automobile 12 and moves forward as being pushed out, the shock is buffered by the cushion 46k and he/she has fastened the seat belt 46b, and thereby he/she is kept in a state of being constrained on the floor panel 46a. Thus, even if the vehicle speed of the automobile 12 is a low speed, the experience person J can feel to receive a strong shock force and terribleness of a traffic accident by his/her body at the time of the head-on collision.

Thus the collision accident simulators and the collision accident simulation methods related to the first to fifth embodiments of the present invention simulate collision accidents for imitating the traffic weak such as a pedestrian and a two-wheeled vehicle; make an experience person experience a simulation traffic accident; thereby let the experience person directly feel a misery and terribleness of the traffic accident by his/her body, strongly have a feeling that “he/she would not like to encounter a traffic accident,” and heighten his/her conscious mind for the traffic safety; and thereby can make him/her contribute to the reduction of traffic accidents.

Meanwhile, the collision accident simulators and the collision accident simulation methods related to the present invention are not limited to the first to fifth embodiments, various remodeling and variations are available without departing from the spirit and scope of the invention, and it goes without saying that the invention covers the remodeling and variations.

For example, so as to simulate a side face collision, the two-wheeled vehicle 16 (see FIGS. 8 and 14) in the second embodiment may be any of a two-wheeled vehicle 56, which is comprised of an electric bicycle and runs by itself by an electric motor (not shown); and another two-wheeled vehicle 56, which is comprised of a general bicycle, is pushed through hands by a human being, and is pushed out onto the drive road 4.

In addition, the destructive member 16f shown in FIG. 10 is not limited to wood and, for example, may also be a bar-form member such as styrene foam that is destroyed or separated by a comparatively weak shock force.

Inside the dummy doll 3 (see FIG. 2) and the dummy doll 13 (see FIG. 10) as any of a core member and a skeleton member, it is also available to provide any of a comparatively easily destructive member by a shock force such as any of wood and styrene foam, which is a same material as that of the destructive member 16f (see FIG. 10), and an easily separable member.

Thus composed, when the dummy doll 3 (see FIG. 2) and the dummy doll 13 (see FIG. 10) receive the shock force, the core member folds as a human being has a bone broken, whereby a traffic accident can be repeated as any of a pedestrian and a cyclist getting on a two-wheeled vehicle actually encounters the traffic accident.

1. A collision accident simulator comprising:
a vehicle for driving on a predetermined drive road; and
a collision object for moving in an intersectional direction for a driving direction of said vehicle and colliding with said vehicle.

2. A collision accident simulator according to claim 1 further comprising a collision object movement apparatus for moving said collision object at a road side,
wherein said collision object movement apparatus comprises:
a support pillar vertically provided at a road side of said drive road;
a rail member orthogonally provided for said drive road at a higher position of said support pillar than said vehicle;
a hanger member for hanging said collision object from said rail member; and
a movement mechanism for moving said hanger member in a transversal direction for said drive road.

3. A collision accident simulator according to claim 2, wherein said collision object is comprised of a dummy doll and said dummy doll moves from a road side to center side of said drive road by said movement mechanism.

4. A collision accident simulator according to claim 1, wherein said vehicle comprises a guard member for guarding said vehicle body at a front face portion, and wherein said collision object provides a destructive member for indicating a shock strength at the time of a collision with said vehicle at a height position where said guard member collides with said vehicle.

5. A collision accident simulator according to claim 1, wherein said collision object is comprised of a two-wheeled vehicle where training wheels are provided at left and right of a vehicle body.

6. A collision accident simulator according to claim 1, wherein said collision object further comprises:
a seat for an experience person who experiences a simulation collision accident, where said vehicle collides with the collision object;
a seat belt for constraining said experience person; and
a shock experience carriage that mounts said seat and said seat belt and comprises a carriage stage under which a plurality of wheels are provided.

7. A collision accident simulator according to claim 1, wherein in said vehicle is placed a seat for an experience person who experiences a simulation collision accident of colliding with said collision object.

8. A collision accident simulator according to claim 2, wherein in said vehicle is placed a seat for an experience person who experiences a simulation collision accident of colliding with said collision object.

9. A collision accident simulator according to claim 3, wherein in said vehicle is placed a seat for an experience person who experiences a simulation collision accident of colliding with said collision object.

10. A collision accident simulator according to claim 4, wherein in said vehicle is placed a seat for an experience person who experiences a simulation collision accident of colliding with said collision object.

11. A collision accident simulator according to claim 5, wherein in said vehicle is placed a seat for an experience person who experiences a simulation collision accident of colliding with said collision object.

12. A collision accident simulator according to claim 6, wherein in said vehicle is placed a seat for an experience person who experiences a simulation collision accident of colliding with said collision object.

13. A collision accident simulation method for simulating a simulation collision accident, the method comprising the steps of:
riding an experience person for experiencing the simulation collision accident on any of a vehicle and a collision object; and
making said collision object collide with said vehicle,
wherein said vehicle drives on a predetermined drive road.
